(19) United States
(12) Patent Application Publication
(10) Pub. No.: US 2011/0302287 A1
(43) Pub. Date: Dec. 8, 2011

(54) QUALITY OF SERVICE CONTROL

(76) Inventors: Kishore Kumar MUPPIRALA, Bangalore (IN); Satish Kumar MOPUR, Bangalore (IN); Dinkar SITARAM, Bangalore (IN)

(21) Appl. No.: 12/794,552

(22) Filed: Jun. 4, 2010

(51) Int. Cl. G06F 15/173

(52) U.S. Cl. 709/223

(57) ABSTRACT

Method(s) for providing Quality of Service (QoS) control in a plurality of sections of a network environment are described herein. Each of the plurality of sections includes at least one device to provide QoS control in the respective section. Further, in each of the plurality of sections of the network environment, one or more fields of a WIT are identified. An application command, generated at a section of the network environment, is provided quality of service in the plurality of sections, based on the one or more fields identified from the WIT.

### BACKGROUND

In a network environment, multiple applications running over dispersed host devices issue application commands to one or more target devices. For example, in a storage area network (SAN) multiple host devices use several application commands, such as input/output (I/O) commands, to store and retrieve data from the target devices, such as data storage devices, disk drives, and disk arrays.

Generally, in a network environment where multiple hosts have access to a common target device, various factors, such as bandwidth and latency, are controlled to provide an expected Quality of Service (QoS). The multiple applications hosted by the host devices, can be associated with one or more Quality of Service (QoS) parameters. The QoS parameters are indicative of the resources that are to be allocated to the associated application command to achieve the expected QoS. The expected QoS may be achieved, for example, by allocating a traffic capacity, or by providing an access to a resource or to another application, based on the desired priorities requested by any of the devices connected to the network.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an exemplary network environment, in accordance with an embodiment of the present invention.

FIG. 2 illustrates an exemplary workload identification tag, in accordance with an embodiment of the present invention.

FIG. 3 illustrates an exemplary QoS control system in a network environment, in accordance with an embodiment of the present invention.

FIG. 4 illustrates an exemplary method for providing QoS control in a network environment, in accordance with an embodiment of the present invention.

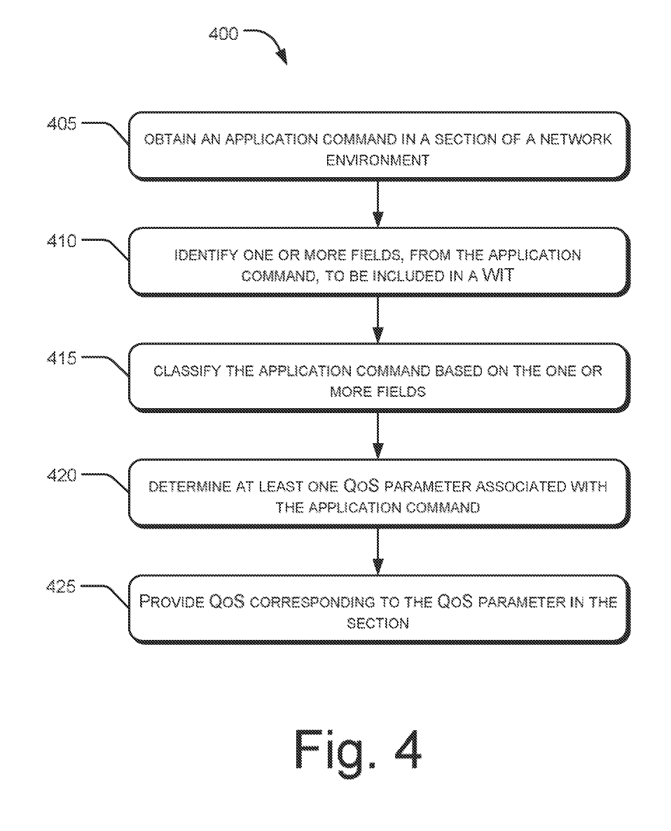

### DETAILED DESCRIPTION

Systems and methods for providing quality of service (QoS) control in a network environment are described. The systems and methods can be implemented in a variety of operating systems, such as Hewlett Packard Unix (HP-UX). Further, the systems and methods can be implemented in a variety of virtual machine (VM) environments using a variety of system architectures and hardware, such as Hyper-V architectures, and Multi-Core architectures, clusters, and the like.

A network environment can include one or more host devices running multiple applications. The applications generate a plurality of application commands or workloads. The application commands, such as input/output commands, may include a storage resource request, a request for a network resource, a processing resource request, etc. The application commands, generally, share resources, for example, processing capabilities and storage capabilities because of the limited availability of these resources. In such a network environment, performance of the different two application commands may get affected. The performance can be indicated through performance characteristics such as, throughput, responsiveness, and latency. In order to avoid such a scenario, various classification and QoS control techniques are implemented to classify and accordingly prioritize the application commands. Generally, the QoS control techniques facilitate QoS control at a component level of the network environment, i.e., the QoS techniques may not provide end-to-end QoS control. In other words, such QoS control techniques provide a single point of control, i.e., QoS control is provided at only one section of the network environment.

In one example, two different application commands accessing a same target device may be classified with similar priorities at the target device by the QoS control techniques, and accordingly would get the same expected QoS. In such a case, a critical and a non-critical application executed on a same host device would get a same priority at the target device. In another example, two similar application commands accessing different logical units of a target device may have a similar classification. In said example, prioritization of routing the two application commands in a network may be based on the target device ports instead of the logical units being accessed, which in turn may lead to congestion at the target device, thereby affecting the performance of the two application commands.

In one embodiment of the present invention, systems and methods to provide an end-to-end QoS control are described. The network environment includes, for example, three sections, namely, a host section having one or more host devices, a target section having one or more target devices, and a network section interconnecting the host section and the target section. The various sections may be divided into further sections, for example, a host section may include a hypervisor section, an operating system section, etc.

In one implementation, the end-to end QoS control is achieved by providing QoS control at a plurality of sections of the network environment. For example, the QoS control may be provided in the host section and the target section. In another example, the QoS control may be provided in the host section, the network section, and the target section. Thus, it will be understood that the QoS control may be provided in two or more sections of the network environment.

To provide classification and QoS control, a tag, referred to as a workload identification tag (WIT), may be considered to be associated with a workload, i.e., an application command. A WIT associated with an application command, such as an input output (I/O) command, includes a plurality of fields indicative of attributes of various sections of a network environment. The QoS control may be provided in the plurality of sections based on one or more fields of a WIT associated with an application command. Further, QoS control may be provided in various sections by using different fields of the workload identification tag in different sections or same fields in different sections of the network environment.

In one implementation, QoS control may be provided in a section using one or more fields, which are indicative of an attribute of the section, i.e., in which QoS control is to be provided. In another implementation, a QoS control is provided in a section based on one or more fields of WIT such that at least one field, from the one or more fields, is indicative of an attribute of a section other than the section in which QoS control is to be provided. In other words, in case, QoS control is to be provided in the host section, then the QoS control may be provided based on an attribute of another section, for example, the target section. An example of a field that is indicative of an attribute of the target section in the present case can be Logical Unit Number (LUN) ID. As already mentioned, the workload identification tag includes one or more fields. Examples of the fields may include, but are not limited to, an application ID, a host virtual port ID, a host physical port ID, an interconnect ID, a target physical port ID, and a target virtual port ID.

Further, one or more QoS parameters may correspond to each of the WITs. In an implementation, a QoS parameter may include a QoS value indicative of the QoS expected from the entire network environment or the various sections of the network environment. Examples of the QoS parameters include, but are not limited to, throughput, bandwidth, transit delay, jitter, loss ratio, and error rate. The QoS corresponding to the QoS parameter associated with the application command is provided in one or more sections of the network.

In order to provide the expected QoS, scheduling of the application commands may be performed based on the QoS parameters corresponding to the WITs associated with the application commands. The scheduling of the application commands may manage processing times for various application commands based on the corresponding QoS parameters. The scheduling may also facilitate a balanced workload division of various resources of the section, thereby preventing an application command from monopolizing a particular resource. Thus, the scheduling, based on the WIT, helps in achieving an optimal QoS for the application commands.

In one example, QoS control may be provided in the host section, with respect to a first QoS parameter, based on the fields, such as the application ID and the target physical port ID, of a WIT. Accordingly, the application command associated with the WIT may be scheduled to achieve the QoS based on both the application ID and the target physical port ID, thereby providing an end-to-end QoS control. Further, a second QoS parameter corresponding to a QoS to be achieved in the target section may also be associated with the application command. The QoS corresponding to the second QoS parameter may be provided in the target section based on fields, such as the application ID, the target physical port ID, and the LUN ID, of the WIT. Accordingly, the application command is classified and scheduled at the host section to achieve QoS corresponding to the first QoS parameter, as described above, and at the target section to achieve QoS corresponding to the second QoS parameter.

Specific fields of the WIT used in the examples described herein may differ for various QoS implementations. Alternatively, additional fields may be added or deleted from the WIT. It will be appreciated that the examples discussed herein are merely for illustration and not to limit the scope of the invention.

Devices that can implement the disclosed method(s) include, but are not limited to, servers, desktop computers, hand-held devices, multiprocessor systems, workstations, microprocessor based programmable consumer electronics, laptops, network computers, minicomputers, mainframe computers, and the like.

While aspects of described systems and methods for providing QoS control in a network environment can be implemented in any number of different computing devices, environments, and/or configurations, the implementations are described in the context of the following exemplary system architecture(s).

### Exemplary Systems

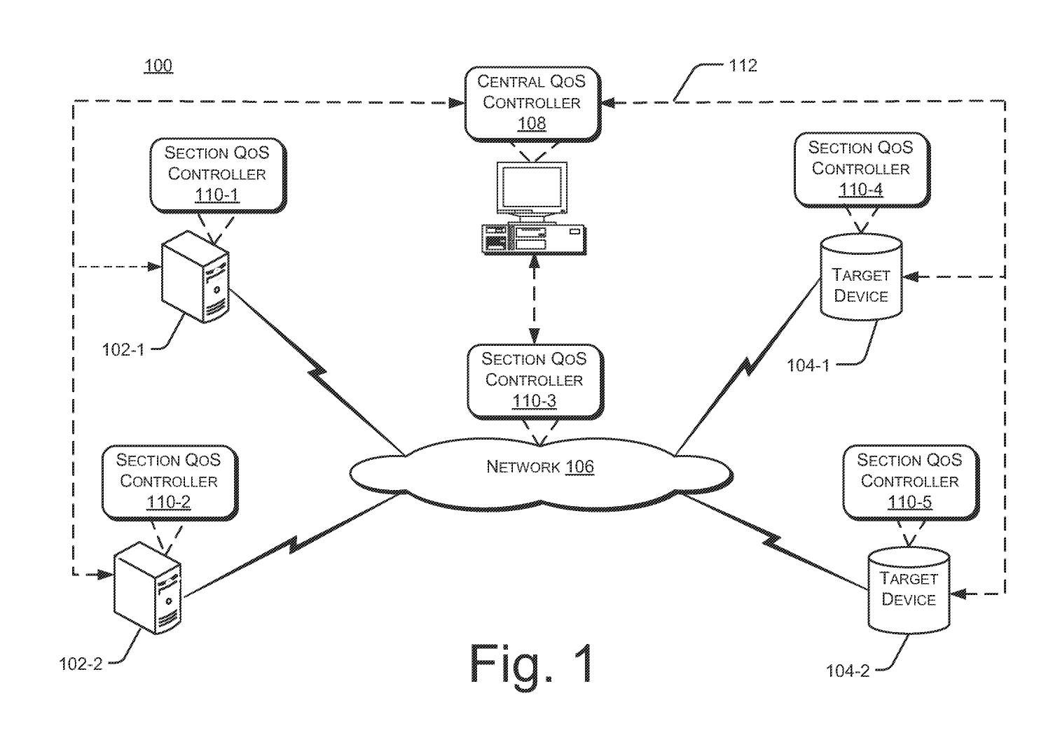

FIG. 1 illustrates an exemplary network environment 100 implementing quality of service (QoS) control, in accordance with an embodiment of the present invention. The concepts described herein can be applied to achieve QoS control in any network environment having a variety of network devices, such as routers, bridges, computing devices, storage devices, and servers. Further, the network environment 100 may be based on a storage area network (SAN). The network environment 100 may be based on different standards or protocols for physically connecting and transferring data between the devices provided in the network environment 100. Examples of such standards include, but are not limited to, small computer system interface (SCSI), internet SCSI (iSCSI), Serial Attached SCSI (SAS), Fibre Channel, Fibre Channel over Internet Protocol (FCIP), and Fibre Channel over Ethernet (FCoE).

In one implementation, the network environment 100 includes a plurality of host device(s) 102, such as host devices 102-1 and 102-2, communicating with one or more target device(s) 104, such as target devices 104-1 and 104-2, via a network 106. The host devices 102 may also interact with each other.

The host devices 102 may be any networked computing device, for example, a personal computer, a workstation, or a server, that hosts various applications and can provide service to, and request services from, other devices connected to the network 106. In one implementation, each of the host devices 102 includes one or more applications, one or more operating systems, and one or more interfaces. The host devices 102 may also include physical hardware, virtual machines, or any combination thereof.

The network 106 may be wireless or wired network, or a combination thereof. The network 106 can be a collection of individual networks, interconnected with each other and functioning as a single large network, for example the Internet or an intranet. Examples of such individual networks include, but are not limited to, Storage Area Networks (SANs), Local Area Networks (LANs), Wide Area Networks (WANs), and Metropolitan Area Networks (MANs). The network 106 may also include network devices such as hubs, switches, routers, and so on.

The target devices 104 may be computing devices having data storage capabilities and which can provide a variety of services to the host devices 102. Examples of the target devices 104 include, but are not limited to, disk arrays, disk drives, tape drives, optical drives, small computer system interface (SCSI) devices, fibre channel devices, storage servers, block storage devices, and so on.

In one implementation, the network environment 100 further includes a central QoS controller 108. The central QoS controller 108 can be implemented in a computing device, such as a server, a desktop computer, a hand-held device, a multiprocessor system, a workstation, a microprocessor based programmable consumer electronics, a laptop, a network computer, a minicomputer, a mainframe computer, and the like. The central QoS controller 108 may be external to three sections, i.e., a host section, a network section, and a target section, of the network environment 100, or may be provided in any one of these sections. In one implementation, the central QoS controller 108 facilitates centralized management and QoS control of the network environment 100. The central QoS controller 108 may also be configured to monitor, adjust, and optimize performance characteristics of the network environment 100 so that an expected QoS may be achieved in one or more sections of the network environment 100.

The central QoS controller 108 may communicate with one or more section QoS controller(s) 110, such as section QoS controllers 110-1, 110-2, 110-3, 110-4, and 110-5, via a link 112 (illustrated as broken lines in FIG. 1). The link 112 illustrates communication paths or couplings between the section QoS controllers 110 and the central QoS controller 108. The link 112 may be a wireless network or a wired network, or a combination thereof.

Further, the central QoS controller 108 may interact with the section QoS controllers 110 through a communication path other than the one used for communicating with main data or payload, i.e., the central QoS controller 108 may communicate with the section QoS controllers 110 through an out of band mechanism. Alternately, the central QoS controller may interact with the section QoS controllers 110 through in-band control mechanisms, i.e., the data pertaining to QoS control may be transmitted through a communication path same as that used for communicating with the main data. Further, the various section QoS controllers 110 may communicate with each other through the central QoS controller 108.

In one implementation, the section QoS controllers 110 may be provided in each of the sections of the network environment 100 to control resources of the relevant section. For example, each of the host devices 102 may be associated with the section QoS controller 110, such as the section QoS controllers 110-1 and 110-2, for providing QoS control in the host section. Likewise, each of the network devices, such as switches, in the network section may be associated with the section QoS controller 110-3, to achieve QoS control in the network section. Similarly, each of the target devices 104 in the target section may be associated with the section QoS controllers 110-4 and 110-5 to achieve QoS control in the target section. Alternately, the host section may include a common host QoS controller for all the host devices 102. Similarly, the network section and the target section may also include a common network QoS controller and a common target QoS controller, respectively. Further, the section QoS controllers 110 may be provided external to the respective devices to provide QoS control. For example, the section QoS controller 110-4 can be external to the target device 104-1 and accordingly the section QoS controller 110-4 may be interfaced with the target device 104-1 to provide QoS control.

Although the present subject matter is explained in considerable detail with reference to individual section QoS controllers corresponding to each section of the network environment 100, it will be understood that the network environment 100 may include a section QoS controller provided only in one section of the network environment. For example, the network environment 100 may include the central QoS controller 108 coupled to a section QoS controller, such as the section QoS controller 110-1 provided in only one section of the network environment 100.

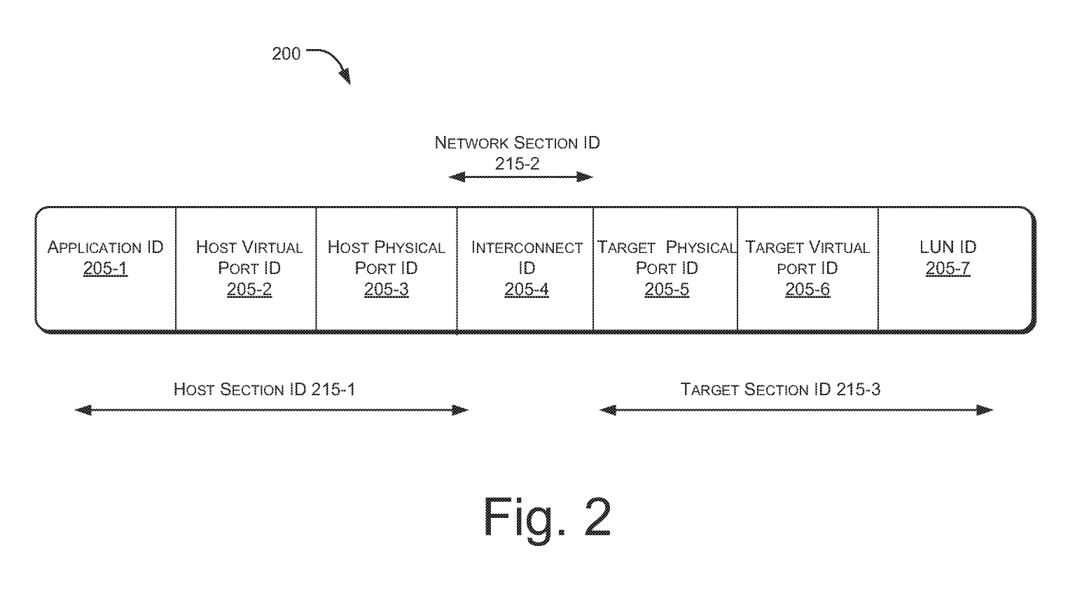

In an implementation, a workload identification tag is considered to be associated with an application command. The workload identification tag may include a plurality of fields, for example, an application ID, a host virtual port ID, a host physical port ID, an interconnect ID, a target physical port ID, a target virtual port ID, and a logical unit number (LUN) ID. The section QoS controller 110 identifies one or more fields of a workload identification tag associated with the application command to provide QoS control in respective sections. The workload identification tag and the fields will be explained in detail with reference to description of FIG. 2.

Based on the identified fields of the workload identification tag, the section QoS controllers 110 may associate a QoS parameter with the application command. Subsequently, the section QoS controllers 110 may perform scheduling of the application command to provide QoS in the respective sections based on the QoS parameter.

In one implementation, the section QoS controllers 110 obtain information pertaining to the QoS parameters corresponding to the workload identification tags from the central QoS controller 108. The QoS parameters associated with an application command may be different for different sections, or may be same for two or more sections. The central QoS controller 108 may communicate the information pertaining to the QoS parameters and the workload identification tags to the section QoS controllers 110 via the link 112. As an example, various section QoS controllers may use different fields in different sections or same fields in different sections of the network environment 100.

FIG. 2 illustrates an exemplary workload identification tag (WIT) 200, in accordance with an embodiment of the present invention. The WIT 200 may comprise information pertaining to the three sections, i.e., the host section, the network section, and the target section, of the network environment. In one implementation, the WIT 200 may be indicative of a stream associated with a workload, such as an application command, generated by the host device 102. The stream may be defined as a path taken by the application command between the host device 102 hosting one or more applications and an end LUN device of the target device 104.

The WIT 200 includes one or more fields 205 providing information regarding the stream associated with the application command. Examples of the fields 205 include, but are not limited to, an application ID 205-1, a host virtual port ID 205-2, a host physical port ID 205-3, an interconnect ID 205-4, a target physical port ID 205-5, a target virtual port ID 205-6, and LUN ID 205-7. It will be understood that the fields 205 illustrated in FIG. 2 are only for the purposes of illustration, and not as a limitation. Further, based on the nature of classification required, the WIT may also be modified. For example, one or more fields 205 may be populated in the WIT 200 or may be deleted from the WIT 200

The application ID 205-1 may be encoded as a group ID embedded in the fields of a protocol frame, such as SCSI GROUP ID or FCP_Priority field of FCP_CMND frame of Fibre Channel Protocol, which may be used to identify an application that generated the application command. For example, in case of HP-UX operating system, the application command may include an encoding of a process resource manager (PRM) group ID. The host physical port ID 205-2 and the host virtual port ID 205-3 may correspond to the ports through which the application command is routed in the host device 102. In one implementation, the host physical port ID 205-2 may be a port ID of the physical port of the host device 102 and the host virtual port ID 205-3 is a virtual port. Examples of a virtual port may include an N-port ID virtualization (NPIV) port associated with a world wide name (WWN) of a port.

The interconnect ID 205-4 may correspond to a network device ID, which may be a physical device or a virtual device, through which the application command may be routed. For example, if the network 106 supports virtual fabric technology, the interconnect ID 205-4 may be a virtual fabric (VF) tag. In virtual fabric technology, a port of a switch can be divided into groups such that each can function like a different physical switch.

The target physical port ID 205-5 and the target virtual port ID 205-6 correspond to the ports through which the application command accesses the target device 104. In one implementation, the target physical port ID 205-5 may be the port ID of the physical port of the target device 102 and the target virtual port ID 205-6 may be V_port of NPIV associated with the physical port. The LUN ID 205-7 may be an address for an individual storage device, such as a data storage device, or disk drive, managed and presented by the target device 104 for use by the host devices 102. For example, each disk drive in a disk array is provided with a LUN ID.

For the purpose of explanation, and not as a limitation, the WIT 200 may be understood to include at least a host section ID 215-1, a network section ID 215-2, and a target section ID 215-3 to identify a stream associated with an application command. Further, there may be overlap of the fields 205 in the three section IDs 215-1, 215-2, and 215-3.

The host section ID 215-1 may include, for example, the application ID 205-1 and a source port ID, such as, the host physical port ID 205-2, and the host virtual port 205-3, and provide information pertaining to the attributes of the application command and the host device 102 hosting the application command. The source port ID may be the host virtual port ID 205-3 in case the host device is capable of operating a virtual machine and a host section QoS controller, such as the section QoS controller 110-2, routes the application command though a virtual port of the host device 102. In one implementation, the network section ID 215-2 may include the interconnect ID 205-4, which may be considered as an attribute of the network section. Accordingly, the network section ID 215-2 provides a network component through which the application command is routed to a target device.

The target section ID 215-3 may include, for example, the target port ID, such as, the physical port ID 205-5 and the target virtual port ID 205-6, and the LUN ID 205-7, thereby providing information regarding the target device 104 and the LUN of the target device 104 accessed by the application command. Therefore, in case the target device 104 is capable of supporting virtual environment, the target port ID may be the target virtual port ID 205-6. Thus, the WIT 200 may include any combination of the fields 205.

Although the fields 205 are shown to be contiguous, the fields 205 may be located at different offsets of a payload. The offsets can be based on a protocol that carries the application command from the host devices 102 to the target devices 104. For example, if the network environment 100 employs a fibre channel (FC) based protocol, the relevant fields 205 may be located at various offsets in an FC frame of the application command. The WIT 200 may be in a header preceding the payload in the FC frame. In one implementation, one or more fields 205, such as the host physical port ID 205-2, the host virtual port ID 205-3, the target physical port ID 205-5, and the target virtual port ID 205-6, may be a part of in-band information corresponding to the application command. It may be understood that these fields are a part of the FC frame corresponding to the application command.

Generally, by the time, the application command reaches an interface, such as a host bus adaptor, of the host device 102-1, and a corresponding FC frame is constructed, the information pertaining to the source port ID is already associated with the application command. Additionally, the information pertaining to the LUN, which the application command intends to access, may also be available in the corresponding FC frame. Thus, information pertaining to the host physical port ID 205-2, the host virtual port ID 205-3, the target physical port ID 205-5, the target virtual port ID 205-6, and the LUN ID 205-7, which were gathered from the corresponding FC frame, may be dynamically updated in the WIT 200. Accordingly, these fields may not be populated in the application command by the section QoS controllers 110, and the section QoS controller 110 may determine the fields of the FC frame corresponding to the application command.

Additionally, one or more fields, such as the application ID 205-1 and the interconnect ID 205-4, may not be present in the in-band information associated with the application command. In one implementation, if one or more fields 205 are not present in the in-band information, the section QoS controllers 110 may populate the required fields 205 in the FC frame corresponding to the application command. For example, the section QoS controller 110-1 and 110-2 may populate the application ID 205-1 and the network QoS controller 110-3 may insert the interconnect ID 205-4 in the WIT 200 and subsequently encode the same into the associated FC frames. Thus, the section QoS controller 110 may modify the WIT 200 based on the nature of the classification required in various sections of the network environment 100.

In another implementation, the central QoS controller 108 may interact with a controller other than the section QoS controller 110 to populate one or more fields 205 in the FC frame. This additional controller may be deployed in any one more devices including the host devices 102, the network devices, and the target devices 104. In an implementation, a controller located in an operating system of the host device 102, may associate the application 205-1 with the application command. Thus, the WIT 200 may be dynamically updated as the application command passes through the various sections of the network environment 100.

The WIT 200 functions as a global tag, thereby providing information pertaining to the various sections of the network environment 100. The section QoS controllers 110 may classify the application command based on all or some of the fields 205 included within the WIT 200. Accordingly, the QoS control in a section of the network environment 100 can not only be provided based on attributes of a particular section of the network environment 100, but also on the basis of attributes of other sections of the network environment 100. In one implementation, QoS control may be provided in a section based on at least one field of the WIT 200, which is indicative of an attribute of a section other than the section that provides QoS control. In another implementation, QoS control is provided based on at least a first field and a second field of the WIT 200 such that the first field is indicative of an attribute of the section that provides QoS control and the second field is indicative of an attribute of a section other than the section that provides QoS control.

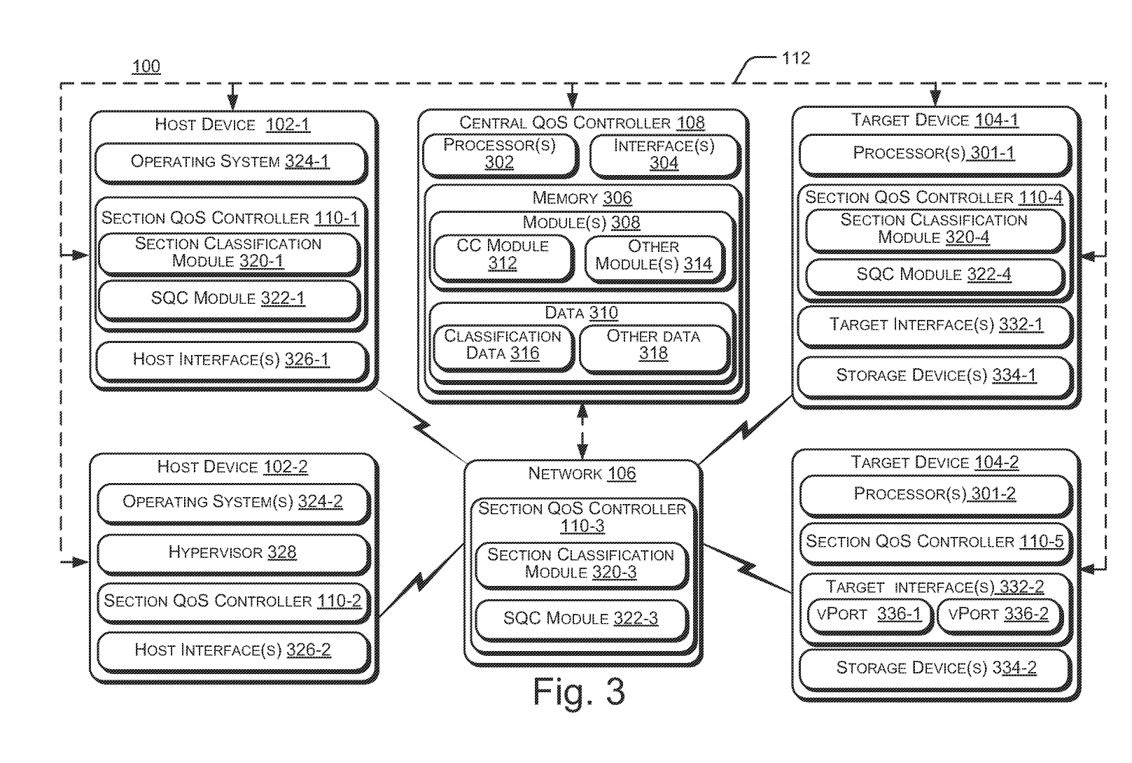

FIG. 3 illustrates an exemplary QoS control system for the network environment 100, in accordance with an embodiment of the present invention. As illustrated, the network environment 100 includes the one or more host device(s) 102, such as the host device 102-1 and 102-2, communicatively coupled to the target devices 104, such as the target devices 104-1 and 104-2 via the network 106. The host devices 102 may include one or more processors (not shown in figures), and a memory coupled to the processor (not shown in figures) for storing various modules and data. Likewise, the target devices 104 may include one or more processor(s) 301, and a memory (not shown in the figures) coupled to the processor 301. In one implementation, the network environment 100 further includes the central QoS controller 108. The central QoS controller 108 includes one or more processor(s) 302, one or more interface(s) 304, and a memory 306 coupled to the processor 302.

The memory provided in various devices, such as the host devices 102, the target devices 104, and the central QoS controller 108, may include any computer-readable medium including, for example, volatile memory such as static random access memory (RAM) and dynamic RAMs, and/or non-volatile memory, such as read only memory (ROM), erasable programmable ROM, flash memories, hard disks, optical disks, and magnetic tapes. The memory also includes module(s) and data. For example, the memory 306 may also include module(s) 308 and data 310. The modules 308 include routines, programs, objects, components, data structures, etc., which perform particular tasks or implement particular abstract data types. In one implementation, the modules 308 include a central classification (CC) module 312 and other module(s) 314. The data 310 may include classification data 316 and other data 318.

The interface 304 facilitates communication of the central QoS controller 108 with other devices, for example, the host devices 102, such as web servers; network devices, such as fibre channel interconnected switches; the target devices 104, such as storage devices; and other external databases. The central QoS controller 108 may communicate with the one or more section QoS controller(s) 110 over the link 112. In one implementation, the section QoS controllers 110 includes, a section classification module 320 and a section QoS control (SQC) module 322. For example, the section QoS module 110-1, for the host device 102-1, includes a section classification module 320-1 and a SQC module 322-1. Likewise, the section QoS module 110-3, for the network 106, includes a section classification module 302-3 and an SQC module 322-3.

As shown, the section QoS controllers 110 may be provided at a plurality of sections, such as, the host section, the network section, and the target section of a network environment. However, as previously mentioned, the QoS controllers 110 may be provided at any one section or at a combination of any two sections of the above mentioned sections. For the purpose of explanation, the description of FIG. 3 is with reference to the host devices 102-1 and 102-2. In one implementation, the host device 102-2 may support operation of a virtual machine that allows operation of a plurality of operating systems on the host device 102-2. Furthermore, the target device 104-2 may be a device capable of running a virtual environment, i.e. the target device 104-2 supports operation of virtual storage devices.

Further, the host device 102-1 includes, for example, an operating system 324-1, the section QoS controller 110-1, and one or more host interface(s) 326-1. As aforementioned, the section QoS controller 110-1 may include the section classification module 320-1 and the SQC module 322-1 for classifying and scheduling an application command generated by an application hosted in the operating system 324-1. The application command may be routed to the target devices 104 via the host interface 326-1.

The host device 102-2 includes, for example, multiple operating system(s) 324-2 for running multiple applications, a hypervisor 328, the section QoS controller 110-2, and one or more host interface(s) 326-2. The operating system 324-1 and the operating systems 324-2, collectively referred to as the operating systems 324, may include a variety of operating systems, such as, HP-UX and Linux. The section QoS controller 110-2 includes the section classification module (not shown in the figure) and an SQC module (not shown in the figure).

The hypervisor 328 provides for virtualization of a software platform as well as virtualization of a hardware platform. This allows multiple operating systems, such as the operating systems 324-2, to run on the host device 102-2 concurrently. The hypervisor 328 can be implemented in different architectures, for example, bare-metal architecture, hosted architecture, etc.

The hypervisor 328 may be responsible for creating, managing, and destroying virtual ports, which are either mapped to or provided by the host interface 326-2, dedicated to route the application commands from each of the operating systems 324-2. The hypervisor 328 may directly control access to processor resources and may enforce an externally delivered policy on memory and physical device access. At the hypervisor 328, application commands, such as IO commands received from the applications via the operating systems 324-2, are processed and dispatched to the target devices 104, through the host interface 326-2.

Further, the network 106 includes, amongst other things, at least one section QoS controller, such as the section QoS controller 110-3. In one implementation, the section QoS controller 110-3 may be provided on each of network devices of the network 106. As previously stated, the section QoS controller 110-3 includes the section classification module 302-3 and the SQC module 322-3.

Furthermore, the target device 104-1 may include, for example, one or more processors 301-1, the section QoS controller 110-4, one or more target interface(s) 332-1, and one more storage devices 334-1, such as disk arrays. Likewise, the target device 104-2 includes, for example, one or more processors 301-2, the section QoS controller 110-5, one or more target interface(s) 332-2, and one more storage devices 334-2. Although storage devices 334-1 and 334-2 are illustrated internal to the respective target devices 104, it will be appreciated that the storage devices 334-1 and 334-2 can be external to the target devices 104. The processors 301-1 and 301-2 may be collectively referred to as the processors 301. The section QoS controller 110-4 includes a section classification module 320-4 and a SQC module 322-4. Similarly, the section QoS controller 110-5 includes a section classification module and a SQC module (not shown in the figure).

Since the target device 104-2 may support virtual machines, the target interface 332-2 may include one or more vPorts, such as a vPort 336-1 and a vPort 336-2. The target interfaces 332-1 and 332-2, collectively referred to as the target interfaces 332, may correspond to interface devices used to connect the target devices 104 to other network devices through a computer bus. Similarly, the host interfaces 326-1 and 326-2, collectively referred to as the host interfaces 326, may correspond to interface devices, such as a host bus adaptor, used to connect the host devices 102 to other network devices.

The interfaces 304, 326, and 332 may include a variety of software and hardware interfaces, for example, interfaces for peripheral device(s), such as a keyboard, a mouse, an external memory, and a printer. The interfaces 304, 326, and 332 can facilitate multiple communications within a wide variety of networks and protocol types for example SAN, LAN, cable, WLAN, cellular, or satellite. To facilitate communication, the interface 304, 326, and 332 may include one or more ports for connecting a number of devices to each other or to other servers. The interfaces 304, 326, and 332 may be based on different or similar standards for physically connecting and transferring data between the devices provided in the network environment 100. Examples of such standards include, but are not limited to, small computer system interface (SCSI), internet SCSI (iSCSI), Serial Attached SCSI (SAS), Fibre Channel, Fibre Channel over Ethernet (FCoE), and Universal Serial Bus (USB).

The processors, such as the processors 301 and 302, provided in various devices of the network environment, can be a single processing unit or a number of units, all of which could include multiple computing units. The processors 301 and 302 may be implemented as one or more microprocessors, microcomputers, microcontrollers, digital signal processors, central processing units, state machines, logic circuitries, and/or any devices that manipulate signals based on operational instructions. Among other capabilities, the processors 301 and 302 are configured to fetch and execute computer-readable instructions and data stored in a memory of a corresponding computing device, such as the target devices 104, and the central QoS controller 108.

In an implementation, a first application (not shown in the figure) executed in the host device 102-1 may generate a first application command, say to read data from a target device, such as the target device 104-1. Similarly, a second application (not shown in the figure) executed in the host device 102-2 may also generate a second application command, which also requests to read data from the target device 104-1 and may compete with the first application command for resources at the target device 104-1.

In order to provide a desired QoS for the first and the second application commands in one or more sections of the network environment 100, the application commands can be classified with the help of the WIT 200. The information associated with the classification of the application commands may be stored in the classification data 316.

In one implementation, the CC module 312 of the central QoS controller 108 may maintain and update the classification data 316. The classification data 316 may include a plurality of WITs, such as the WIT 200, and at least one corresponding QoS. The classification data 316 may be in the form of mapping tables having information pertaining to the fields 205 of the WIT 200 that are to be considered for classifying an application command in one or more sections of the network environment 100.

The classification data 316 with respect to various sections may be maintained as separate mapping tables or combined mapping tables. In one implementation, the central QoS controller 108 is also configured to communicate the classification data 316 corresponding to a section of the network environment 100 to a corresponding section QoS controller. In one implementation, in case the network environment 100 includes the section QoS controller 110 in a single section of the network environment 100, the classification data 316 may include the mapping table with respect to that section alone.

The selection of the fields 205 to be identified from the WIT for the classification of the application commands in a section may be based on the nature of classification requirements in that section. In another implementation, the fields 205 to be identified for the classification in a section may be pre-defined by a user or a system administrator. The CC module 312 may update or modify the classification data 316 based on user-defined policies. The interface 304 of the central QoS controller facilitates transmission of the classification data 316 to the various devices in the network environment 100. Likewise, the host interfaces 326 facilitate receipt of the classification data 316 by the host device 102, and the target interfaces 332 facilitate receipt of the classification data 316 by the target device 104.

The classification data 316 may be provided to the section QoS controllers 110 by the CC module 312. In one implementation, the section classification module 320, provided in each of the section QoS controllers 110, may be configured to dynamically maintain and update the classification data 316. For example, any updates or modification in the classification data 316 owing to alterations in user-defined policies may be communicated by the CC module 312 to the section classification module 320. The section classification module 320 may accordingly update the classification data 316 maintained by the section classification module 320. The section classification module 320 may be configured to identify one or more fields of a WIT, such as the WIT 200, associated with an application command. To identify the fields, the section classification module 320 may map the fields 205, which are selected for classifying the application command in a section, with those present in the in-band information associated with the application command. Based on the mapping, the section classification module 320 identifies the fields and thus the WIT associated with the application command to facilitate classification of the application command.

Thus, the section classification module 320 may identify one or more fields of a WIT, which may be selected based on the information provided by the classification data 316. Therefore, various section classification modules 320, such as the section classification module 320-1, 320-3, and 320-4, may classify the application command based on various fields 205 included in the WIT 200. As previously discussed, the fields 205 selected for the classification of the application commands in the various sections of the network environment 100 may be different for different sections, similar for all the sections, or overlapping.

In one implementation, the section classification module 320, such as the section classification module 320-1 may interact with the operating systems 324 for identification of an application that generated an application command. Additionally or alternately, the section classification module of the section QoS controller 110-2 may be configured to interact with the hypervisor 328 to classify the application commands originating from different operating systems 324, such as the operating systems 324-2, targeting different LUNs in the target devices 104.

Further, the section classification module 320 may be configured to modify a WIT associated with an application command. In one implementation, the section classification modules 320 provided in the section QoS controllers 110-1 and 110-2 may modify the WIT. For example, the section classification modules 320 may modify the WIT by populating or removing one or fields from a WIT associated with an application command i.e., by populating or removing one or more fields from in-band information associated with the application commands. As an example, the section classification modules 320 provided in the section QoS controllers 110-1 and 110-2 can tag an application ID 205-1 with the application command. In another example, the section classification module 320-3 provided in a network device of the network 106 may associate the interconnect ID 205-2 with the application command.

As already mentioned, the section classification module 320 may be configured to remove one more fields from an in-band information associated with the application commands in case a downstream section QoS controller does not require these fields. In one implementation, the section classification module 320-3 may remove the interconnect ID 205-4 from the application commands prior to transmitting the application command to the target device 104. In one implementation, the information pertaining to insertion or removal of one or more fields from the in band information, i.e., modification of WITs associated with the application commands for a section is included in the classification data 316.

As previously mentioned, the classification data 316 also includes QoS parameters corresponding to the WITs. In one implementation, different QoS parameters may be provided for different sections of the network environment 100. Alternately, same QoS parameters may be provided for more than one section of the network environment 100. The SQC module 322 may identify one or more QoS parameters based on the WIT 200 associated with an application command in a section deploying the section QoS controller. The SQC module 322 may perform the scheduling of the application command to provide the required QoS control, corresponding to the QoS parameters, for the application command.

In one implementation, the SQC module 322 may manage and schedule processing times for various application commands based on the QoS parameters. The SQC module 322 may balance workload division for various resources of a section, thereby preventing any application command from monopolizing the resources at any section. Additionally, the SQC module 322 may also decide which of the application commands are to be admitted in a ready queue based on the QoS parameters, the number of application commands that may concurrently execute, and how the QoS control is to be achieved for various applications generating the application commands so that expected QoS can be achieved.

For the host devices 102, the SQC module 322 may be configured to facilitate QoS control for resources such as processors, memory, the operating systems 324, the hypervisor 328, and resources in a storage stack, such as a storage stack associated with the hypervisor 328 or the operating system 324, associated with a stream for an application command. For example, the SQC module 322-1 may control flow rate in a host device 102, such as a server, by controlling throughput for a WIT having an application ID and a LUN ID and associated with an application command. In another example, in a virtual environment, such as in host device 102-2, the control of low rate may be provided based on a WIT including the host virtual port ID and the LUN ID. Accordingly, application commands with different WITs can be scheduled and prioritized accordingly to achieve an optimal QoS.

For example, the SQC module 322, such as the SQC module 322-1 and 322-2, may schedule and prioritize the application commands running on an operating system, such as the operating system 324-1. To schedule and prioritize the application commands, the SQC module 322 may identify the various applications running on the operating system 324-1. The SQC module 322 may implement various scheduling techniques for scheduling the application commands. Examples of the scheduling techniques include, but are not limited to, PRM disk input output (IO) bandwidth control for HP-UX operating system, Class based Kernel Resource Management (CKRM) based IO resource control for a Linux operating system, etc.

Additionally or alternately, the SQC module 322 of the section QoS controller 110-2 may schedule and prioritize the application commands running on multiple operating systems, such as the operating system 324-2, through the hypervisor 328. In this case, the section classification module 320 may provide for the classification of the application commands originating from different operating systems and targeting different LUNs. Accordingly, the SQC module 322 may provide QoS control for these applications.

In another example, the SQC module 322-3 provided in the network 106 may provide network QoS control, such as the rate control of application commands, by providing bandwidth control across network devices, such as fibre channel interconnected switches. To provide QoS control, the SQC module 322-3 may identify port names of the host section ID 215-1 and target section ID 215-2 of a WIT associated with application commands obtained at the network section. The WIT facilitates identification of a stream the application command is associated with. Based on one or more QoS parameters corresponding to the WIT, the SQC module 322-3 may control release rate of the application commands to the target devices 104.

For the target devices 104, the SQC modules 322-4 and 322-5 provided in the target devices 104 may provide the QoS control for resources of the target section. For example, a first application command, having a first application ID, accessing a port having a first port ID of the target device may be sent to a first queue. Similarly, a second application command, also having the first application ID, accesses a port having a second port ID, is sent to a second queue. In said example, the application commands may be scheduled such that the application commands reaching a port with the first ID are provided a higher bandwidth as compared to the application commands reaching a port with the second port ID.

In order to perform scheduling of the application commands, the SQC module 322-4 and 322-5 may employ a variety of scheduling techniques, for example, bandwidth upper and lower bounds on a per stream basis, optimal control of the bandwidth and average latency using workload modeling, and IO request release rate control.

In one implementation, the SQC modules 110 may be configured to provide monitoring data including information pertaining to, for example, throughput performance and latency with respect to the expected QoS for the application commands in the respective sections to other module(s) 314. Based on the monitoring data, the central QoS controller 108 can, for example, monitor whether the required QoS corresponding to the application commands is achieved or not.

The monitoring data may be provided based on a polling driven by the other module(s) 314. Alternately, the SQC modules 110 may provide the monitoring data periodically to the other modules 314. In another implementation, the central QoS controller may store the monitoring data in other data 318 for validation and monitoring purposes. A user may use the monitoring data for updating the classification data 316. For example, the monitoring data may be used to validate whether a given QoS parameter associated with a WIT, for a given section of the network environment 100, is achievable in that section or not. Accordingly, the user may update the classification data 316 to adjust the QoS parameter. Further, the CC module 312 may communicate the updates to the section classification module 320.

The QoS control system described herein provides the flexibility of having end-to-end QoS control, based on the requirements of the network environment 100. For example, a target section QoS controller may not be capable of providing a required QoS in the target section, in such a case, a host section QoS controller may be deployed in the host device 102, which in conjunction with the target section QoS controller helps in achieving the expected QoS for application commands. Accordingly, the QoS control may be provided at multiple points in the network environment 100 using a workload identification tag.

The method 400 may be implemented in a network environment, such as the network environment 100, including virtual devices, non-virtual devices, or a combination thereof. The method 400 is described with reference to a single section QoS controller, such as the section QoS controllers 110 in the network environment 100, it will be understood that for a plurality of section QoS controllers the method 400 can be implemented in each of the plurality of section QoS controllers.

At block 405, an application command is obtained at a section of the network environment. For example, an application command may be obtained in a host section, when the application command is generated in a host device, such as the host device 102-1, of the host section. Additionally or alternately, a target device, such as the target device 104-1, of a target section, may receive the application command. In one implementation, the section classification module 320 may obtain the application command.

At block 410, one or more fields of the application command are identified from a WIT associated with the application command. In one implementation, at least one field, from amongst the one or more fields, indicative of an attribute of a section other than the section that associates the WIT with the application command is obtained. The WIT is indicative of a stream associated with a workload, such as an application command generated by the host device 102-1. Examples of the fields include, but are not limited to, the application ID 205-1, the host virtual port ID 205-2, the host physical port ID 205-3, the interconnect ID 205-4, the target physical port ID 205-5, the target virtual port ID 205-6, and the LUN ID 205-7.

In one implementation, the section classification module 320-1 identifies fields of the WIT based on the classification data 316, which is provided by the central QoS controller 108. For example, a host section QoS controller, such as the section QoS controller 110-1, may identify fields, such as, the application ID 205-1 and the LUN ID 205-7 of the WIT. Further, a target section may identify the fields, such as, the application ID 205-1 and the target virtual port ID 205-6 of the WIT associated with the application command.

At block 415, the application command is classified based on the identified fields of the WIT. As explained above, the WIT provides for classification of the application command to achieve an expected QoS. In one implementation, the section classification module 320 may classify the application command.

At block 420, at least one QoS parameter corresponding to the WIT associated with the application command is determined based on the one or more fields identified at the block 410. The QoS parameter may include a QoS value corresponding to the QoS expected in a section of the network environment. The QoS parameter may be, for example, throughput, bandwidth, transit delay, jitter, loss ratio, and error rate. In one implementation, a QoS parameter corresponding to a WIT may be included in the classification data 316. The classification data 316 may include, for example, mapping tables to map a WIT with a QoS parameter for a given section. In one implementation, the SQC module 322 may identify the QoS parameter corresponding to the WIT associated with the application command.

At block 425, the expected QoS corresponding to the QoS parameter is provided to the application command. In one implementation, scheduling of the application is performed at the respective section to provide the expected QoS. In one implementation, the SQC module 322 schedules the application command to achieve the QoS corresponding to the QoS parameter in the required section. For example, a host section QoS controller, such as the section QoS controller 110-1, may provide QoS control in the host section based on a QoS parameter corresponding to a WIT, which is indicative of QoS in the host section. Further, a target section controller may provide QoS control based on a QoS parameter associated with the WIT, which is indicative of QoS in the target section.

The above mentioned example illustrates an exemplary implementation of the QoS control, based on a WIT and is not intended to be construed as a limitation of the present subject matter. It will be understood that the method 400 can also be implemented in other sections of the network environment to achieve QoS control in the respective section. The WITs, associated with application commands, may include one or fields based on nature of classification and scheduling required in one or more sections of the network environment.

Although embodiments of Quality of Service (QoS) control in a network environment have been described in language specific to features and/or methods, it is to be understood that the invention is not necessarily limited to the specific features or methods described. Rather, the specific features and methods are disclosed as exemplary implementations for the QoS control.

1. A method to provide Quality of Service (QoS) control, the method comprising:
identifying at least one field of a workload identification tag (WIT) associated with an application command generated at a section of a network environment, the network environment comprising, a plurality of sections with each of the plurality of sections comprising at least one device; and
providing, based on the at least one field of the WIT, QoS to the application command in each of the plurality of sections by the at least one device.

2. The method as claimed in claim 1, wherein the WIT is configured to include a plurality of fields indicative of attributes of the plurality of sections of the network environment.

3. The method as claimed in claim 2, wherein the plurality of fields include an application ID, a host physical port ID, a host virtual port ID, an interconnect ID, a target physical port ID, a target virtual port ID, and a logical unit number (LUN) ID.

4. The method as claimed in claim 1, wherein the plurality of sections includes at least two sections selected from a hypervisor section, an operating system section, a host section, a network section, and a target section.

5. The method as claimed in claim 1, further comprising classifying the application command in each of the plurality of sections based on the at least one field identified in the respective sections.

6. The method as claimed in claim 1, further comprising determining, at least one QoS parameter associated with the application command, wherein the at least one QoS parameter is indicative of the QoS provided in the plurality of sections.

7. A system comprising:
a device provided in each of a plurality of sections of a network environment, the device comprising,
a processor; and
a memory coupled to the processor, the memory comprising a section Quality of Service (QoS) controller configured to,
classify an application command in a section using one or more fields of a workload identification tag (WIT) associated with the application command; and
schedule the application command in the section based on the classification, to provide a QoS in the section.

8. The system as claimed in claim 7 further comprising a central QoS controller configured to control the section QoS controller.

9. The system as claimed in claim 7, wherein the section QoS controller is configured to provide monitoring data to a central QoS controller.

10. The system as claimed in claim 7, wherein the system implements a protocol selected from the group consisting of small computer system interface (SCSI), internet SCSI (iSCSI), Serial Attached SCSI (SAS), Fibre Channel (FC), Fibre Channel over Ethernet (FCoE), and Fibre Channel over Internet Protocol (FCIP).

11. The system as claimed in claim 7, wherein the section QoS controller is configured to modify the WIT associated with the application command.

12. A computer-readable medium having a set of computer readable instructions that, when executed, perform acts comprising:
identifying at least one field from an application command, in each of a plurality of sections of a network environment, the at least one field being included in a workload identification tag (WIT) associated with the application command, and
classifying the application command in each of the plurality of sections based on the identifying to provide quality of service (QoS) in each of the plurality of sections.

13. The computer readable medium as claimed in claim 12, wherein the QoS corresponds to one or more QoS parameters associated with the application command, and wherein the QoS parameters are selected from the group consisting of throughput, bandwidth, transit delay, jitter, loss ratio, and error rate.

14. The computer readable medium as claimed in claim 12 further comprising instructions to modify the WIT associated with the application command.

15. The computer readable medium as claimed in claim 12, wherein the at least one field is indicative of an attribute of a section other than the section at which the at least one field is identified.
